(19) United States
(12) Patent Application Publication
(10) Pub. No.: US 2017/0202727 A1
(43) Pub. Date: Jul. 20, 2017

(54) FOLDING STEP FOR USE WITH MOBILITY DEVICE

(71) Applicant: Highlander Inventions Corp., Melville, NY (US)

(72) Inventors: John Andrew Wegener, Granger, IN (US); Laurie Anne Condon, Melville, NY (US)

(73) Assignee: Highlander Inventions Corp., Melville, NY (US)

(21) Appl. No.: 14/997,613

(22) Filed: Jan. 18, 2016

(51) Int. Cl. A61H 3/04; A47C 12/00

(52) U.S. Cl. CPC A61H 3/04; A47C 12/00

(57) ABSTRACT

A device adapted to be installed on a walker is provided where two of the original adjustable feet are removed from the walker and the device is affixed to the remaining vertical tube portions. The device is affixed to the walker in a similar fashion to the adjustable feet. The device has a platform that moves between a stored position and a use position, the stored position is defined by the platform being up and located between the remaining vertical tube portions and the use position is defined by the step being down, allowing the user to sit or stand on the step. When the platform is up, it allows full access to the space around the walker. A leg is connected to the step where the leg hinges down to support the step.

### BACKGROUND OF THE INVENTION

Walkers and other mobility devices are commonly used for people who have difficulty standing, walking, or transitioning between the two. A walker has handles for the user to hang onto and legs that contact the floor and support the handles. Walkers are frequently foldable to become compact, allowing the user to take it with them. This is especially helpful if the user desires to travel. Also, the foldability of the walker allows the user to store it in a closet if the user only needs the walker periodically, such as recovery from surgery or other rehabilitation. At times, the user needs to have a raised step or other load-bearing platform. The current art requires the user to have a secondary device, such as a separate step stool or chair. The secondary device either needs to remain where the user will need it, or be carried around. For people with limited mobility, where moving themselves is difficult or painful, carrying around another device is out of the question.

There are other inventions in the market to assist people getting in and out of vehicles such as an RV; U.S. Pat. Nos. 4,664,227 and 4,113,161 describe some. There are also canes to assist a person in lifting themselves or to climb stairs. For instance, U.S. Pat. Nos. 5,131,494, 3,884,327, 7,509,966, & 7,261,113 describe some of these. However, there are no known methods to provide assistance to step higher built into a walker. Other medical devices, including walkers, have folding platforms, but those are used as a seat and are integral to the walker. These folding seats are not a solution to a user that needs to step up, as they are too high of a surface and are not adapted to be used for standing. An improved walker or mobility device with a foldable standing platform is needed.

### SUMMARY OF THE INVENTION

The invention involves an integral step that is built into or capable of being added to a walker. This adds functionality to the walker where a person who needed the step up assistance would not need to have a separate device to do so. This makes it easier for the family and care takers of the individual to assist that person and to move around just one device. The ease of using this encourages outings, thereby improving overall quality of life to the user. The step allows the user of the walker to raise themselves up onto an examining table or into a car, such as an SUV or minivan, while still having the stability of the walker. The step folds into the walker such that it is portable with the walker without interfering with the primary use of it. The folding action of the step brings down a supporting leg portion where a substantial portion of the weight is carried. When the step is moved to the stored position, a linkage moves the supporting portion out of the way. By locating the step to the side and not the front, the step does not interfere with the user's legs or knees. Further, the location of the step on the side would not interfere with a folding seat, something that is frequently a part of the walker.

Any person who needs stability when walking and needs to raise themselves about 6″ higher than the floor while needing the stability of a walker. This is useful for entering a vehicle with high seats, such as in a SUV or to get a bit higher to sit on an examining table. While an examining table may have a step, the location is often inconvenient at the end of the table, or may be too high for some patients. Also, there typically are no hand rails on an examining table.

The invention is to provide the ability to step up a bit higher while using a walker. Other inventions have built a raised surface, which can be stepped on, into a cane, but not on a walker. A walker has greater stability for a person who is less ambulatory than a person who is able to use a cane. A person in need of a walker now has one device to step higher as opposed to at least two separate devices, a walker and a portable step. The invention is adapted to be used with different styles of walkers, including those that have wheels on one or all sides.

### BRIEF DESCRIPTION OF THE DRAWINGS

A preferred embodiment of this invention has been chosen wherein:

FIG. 1A is a front isometric view of the device as installed on a walker and folded down and facing in;

FIG. 1B is the same view of the device as shown in FIG. 1A with the step partially folded up;

FIG. 1C is the same view of the device as shown in FIG. 1A with the step completely folded up and stored;

FIG. 2 is a bottom isometric view of the device as shown in FIG. 1A;

FIG. 3 is an exploded isometric view of the device;

FIG. 4 is a side view of the device in the down position;

FIG. 5 is a top view of the device in the down position;

FIG. 6A is a top isometric view of the step portion;

FIG. 6B is a bottom isometric view of the step portion;

FIG. 7A is an isometric view of the device installed in an alternative position on a walker in the down position;

FIG. 7B is the same view of the device as shown in FIG. 7A with the step partially folded up;

FIG. 7C is the same view of the device as shown in FIG. 7A with the step folded up;

FIG. 8 is the same view of the device as shown in FIG. 7A with a bar affixed to the walker;

FIG. 9 is a front isometric view of the device as installed on the front of the walker and in the down position; and

FIG. 10 is a front isometric view of the device installed on the front of the walker and in the down position.

### DESCRIPTION OF THE PREFERRED EMBODIMENT

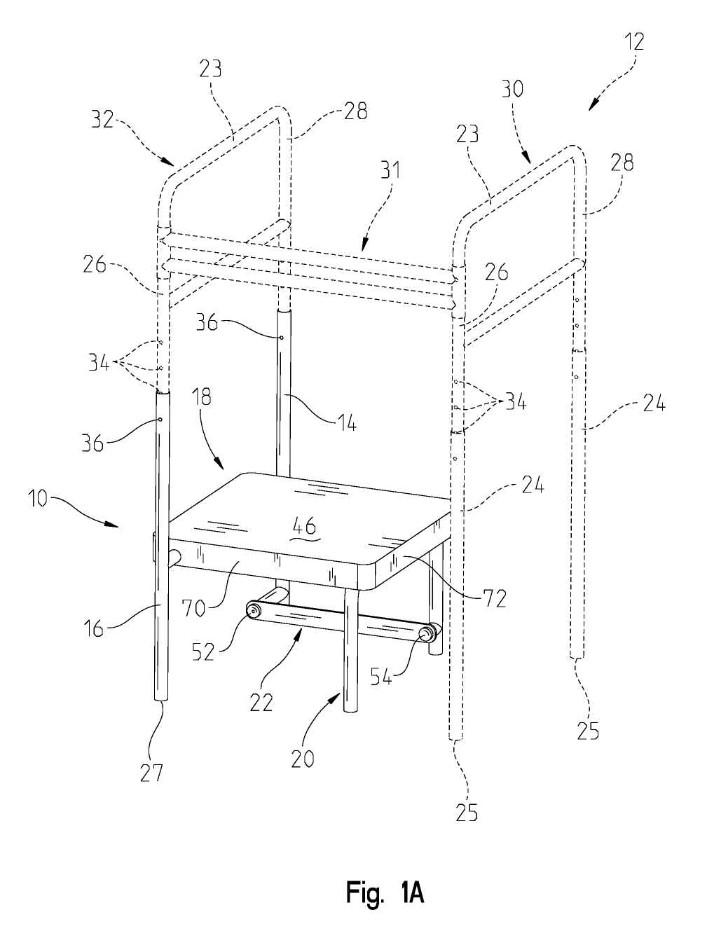

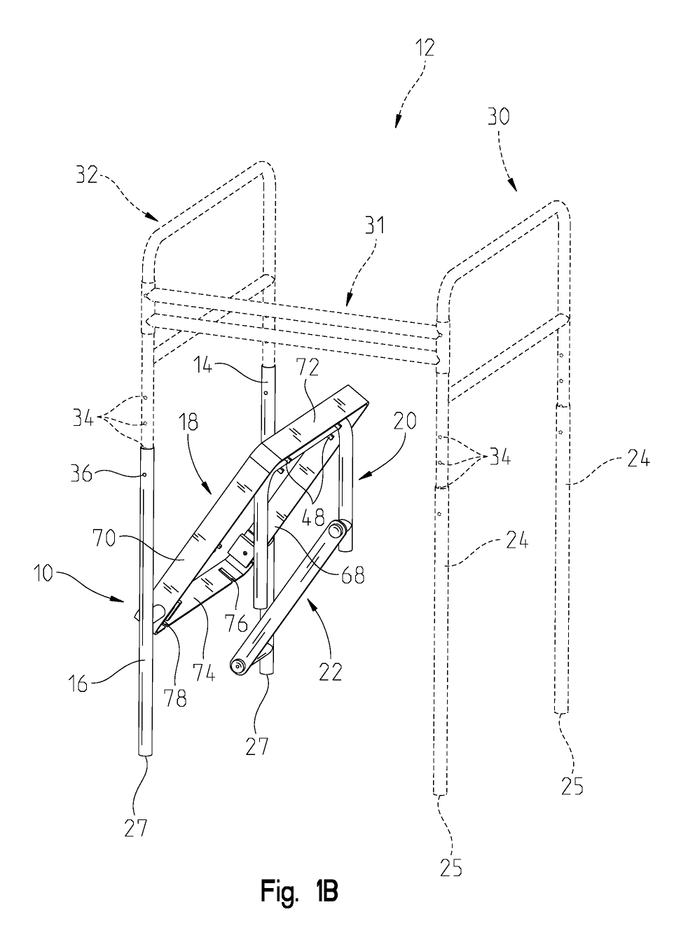

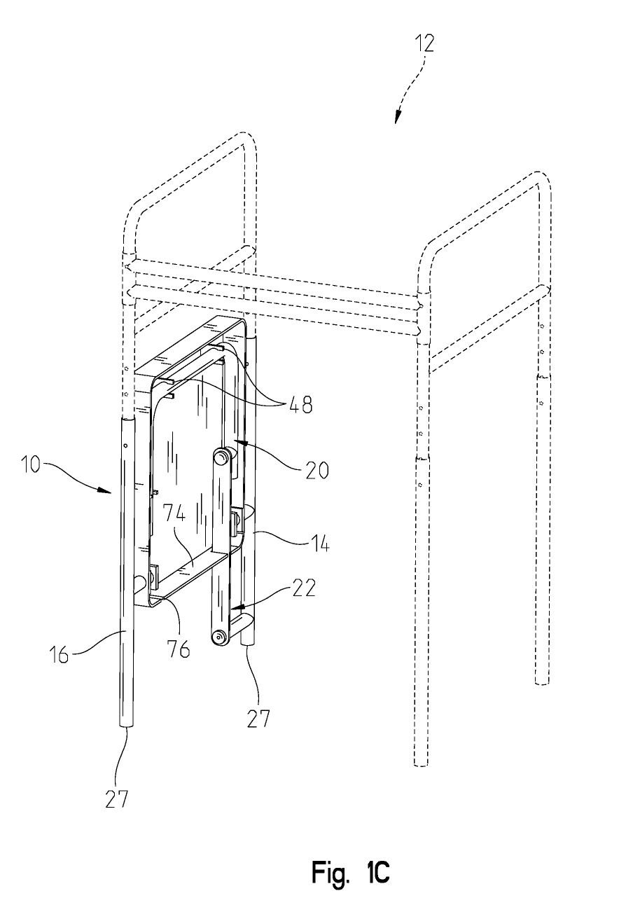

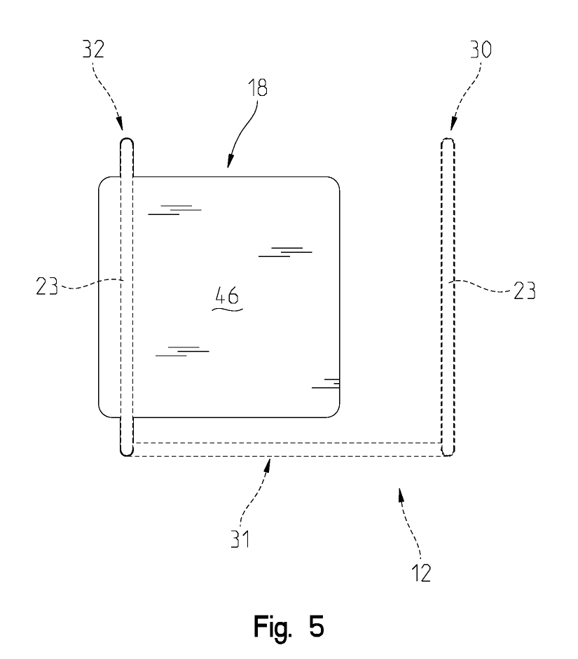

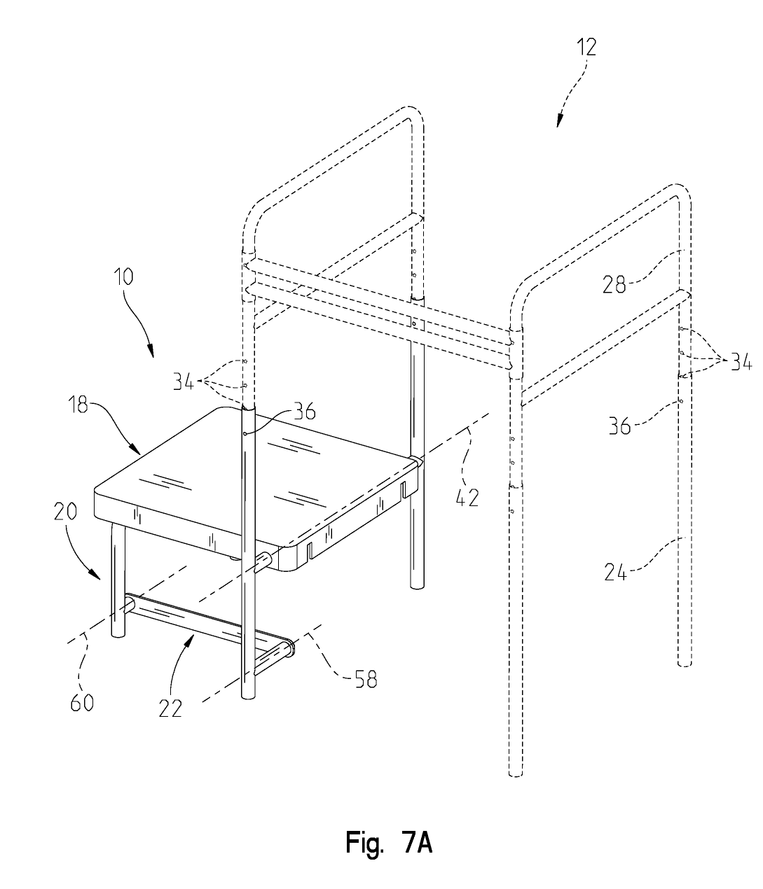

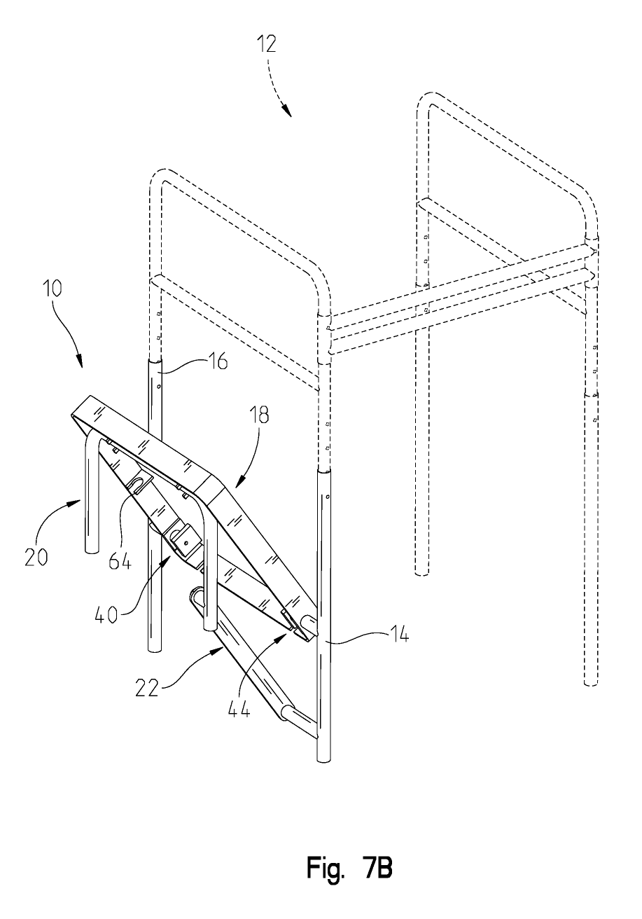

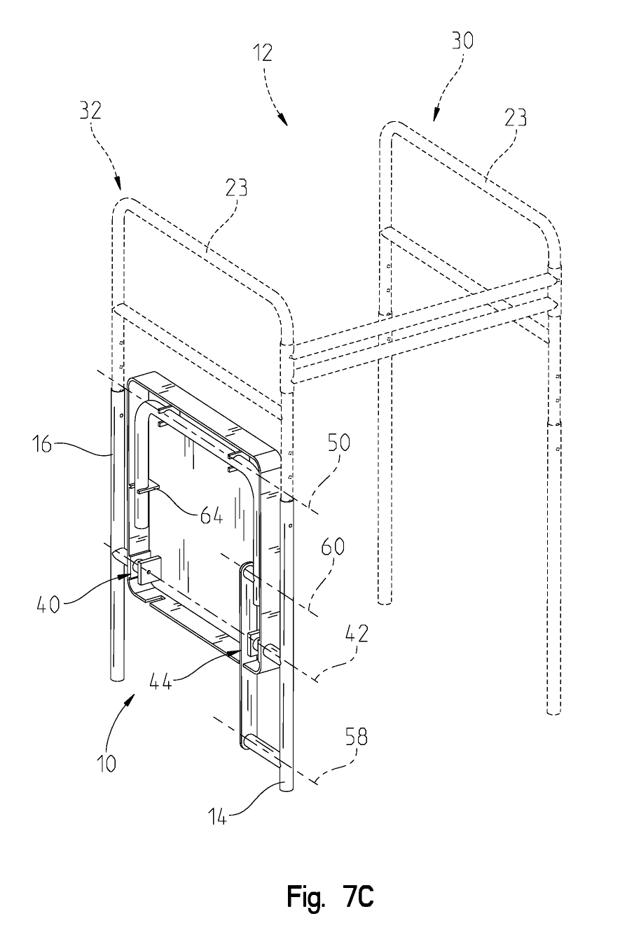

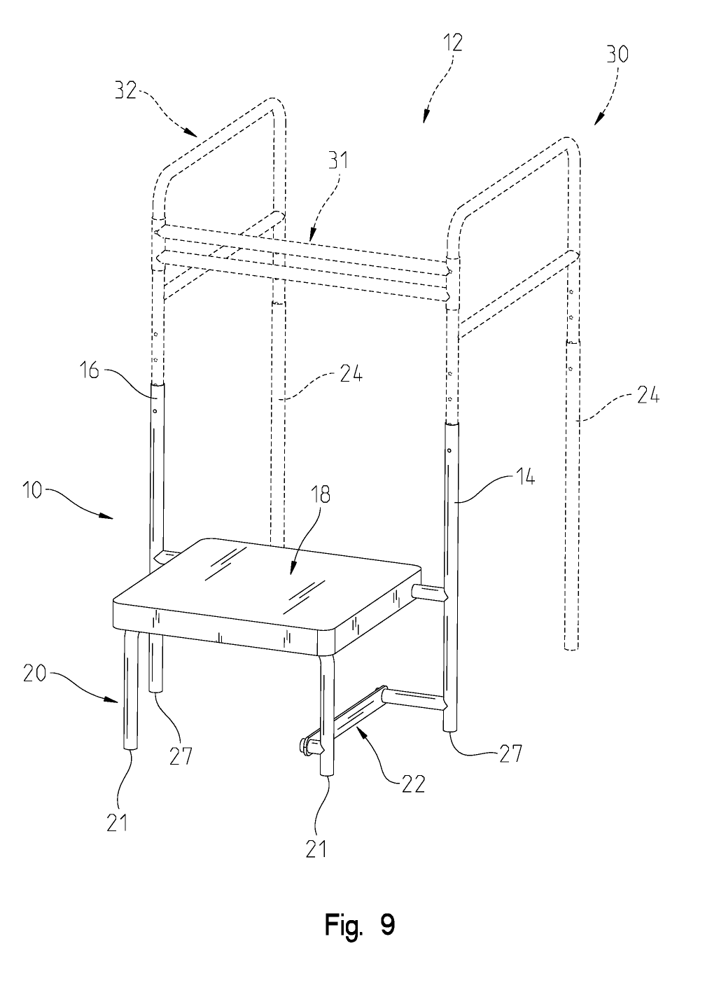

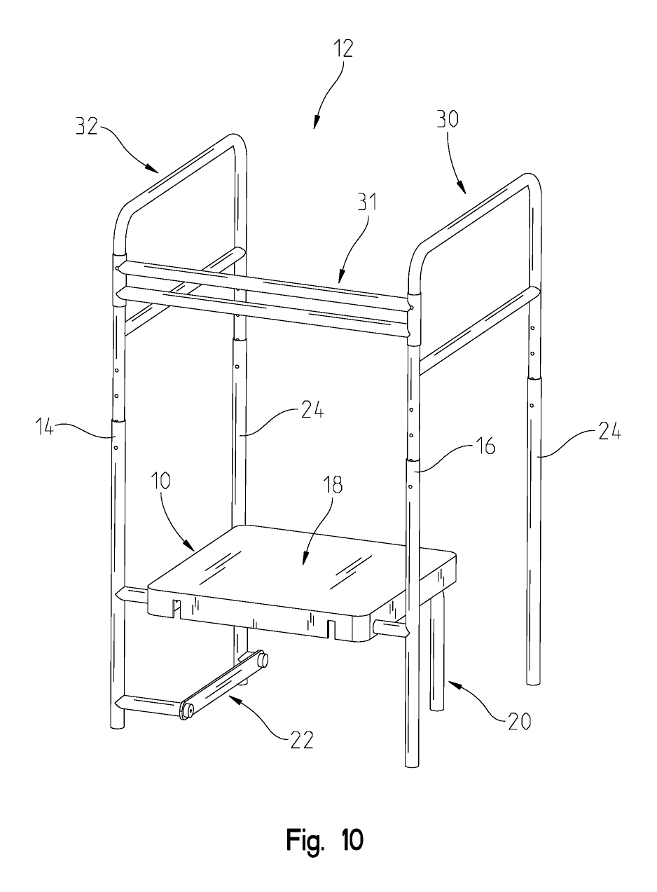

As shown in FIG. 1A and 1B, a folding step 10 for a walker 12 is composed of a first leg, 16, a second leg, 14, a movable platform 18, a unified leg, 20, and a linkage, 22. The folding step 10 is designed to mate with an existing walker 12, shown in FIG. 1A-1C. The existing walker 12 typically has telescopically adjustable legs 24 that adjust the overall height of the handle portions 23. Specifically, the adjustable legs 24 receive or are received by a front tube portion 26 and a rear tube portion 28. The left side 30 is substantially a mirror image of the right side 32 and the two sides are connected by a front side 31. As shown in FIGS. 1, 2, 5, and 7, the left side 30 has the original adjustable legs 24 that are telescopically moveable to their respective tube portions 26, 28. The adjustable legs 24 have feet 25 that are designed to securely rest on the ground or other horizontal surface. In FIGS. 1A-1C, the right side 32 has the folding step 10 installed, but it is contemplated that the folding step 10 is installed on either side. It is further contemplated that the folding step 10 is installed to allow it to fold to the outside as shown in FIGS. 7A-7C. In FIGS. 9, 10, the folding step 10 is attached to the front of the walker 12. The first and second leg 16, 14 have feet 27 that are designed to securely rest on the ground or other horizontal surface. Wheels (not shown) are frequently located on the adjustable legs 24 where the feet 25 are shown. The wheels allow the user to move the walker 12 without having to lift it or drag it along the ground. It is contemplated that wheels (not shown) are located on the bottom of the first leg 16 or second leg 14 (depending on the nature of the walker 12) where feet 27 are shown. It is contemplated that the folding step 10 is integrated into the walker 12

To set the height of the walker 12, the front tube portion 26 and rear tube portion 28 slide either inside or over adjustable legs 24. As shown, the walker 12 has a series of holes 34 on both tube portions 26, 28. On a corresponding leg, there is a hole 36 that can receive a bolt or locking pin (not shown) that locks the leg 16, 14 to the tube portion 26, 28. Alternatively, the legs 16, 14 have a series of holes 34 that receive a button that protrudes from the adjustable legs 24. The button is spring-loaded, allowing the user to press it in and slide the leg into its respective tube portion 26, 28. When the button passes one of the holes 34, the button, being urged by the spring, protrudes through, fixing the telescoped position of the leg 16, 14 to its respective tube portion 26, 28. To move the leg 16, 14 again, the user presses on the button while urging the leg 16, 14 in the desired telescoping direction. The folding step 10 is attached to the walker 12 in the same fashion as the adjustable legs 24, where buttons are spring-loaded and protrude outward from the first 16 and second 14 legs to mate with the holes into its respective tube portion 26, 28. It is contemplated that other methods or mechanical features are used to lock the position of the adjustable legs 24. These include but are not limited to screws, bolts, clamps, and pins. When other methods or mechanical features are used to lock the adjustable legs 24, the front tube portion 26 and rear tube portion 28 of the folding step 10 would contain the same features and mating that the adjustable legs 24 would have.

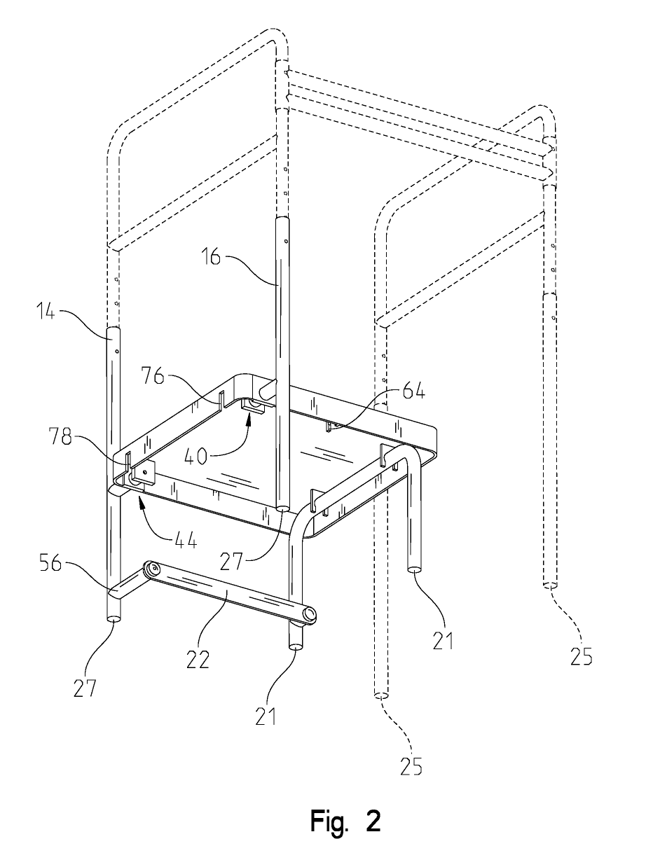

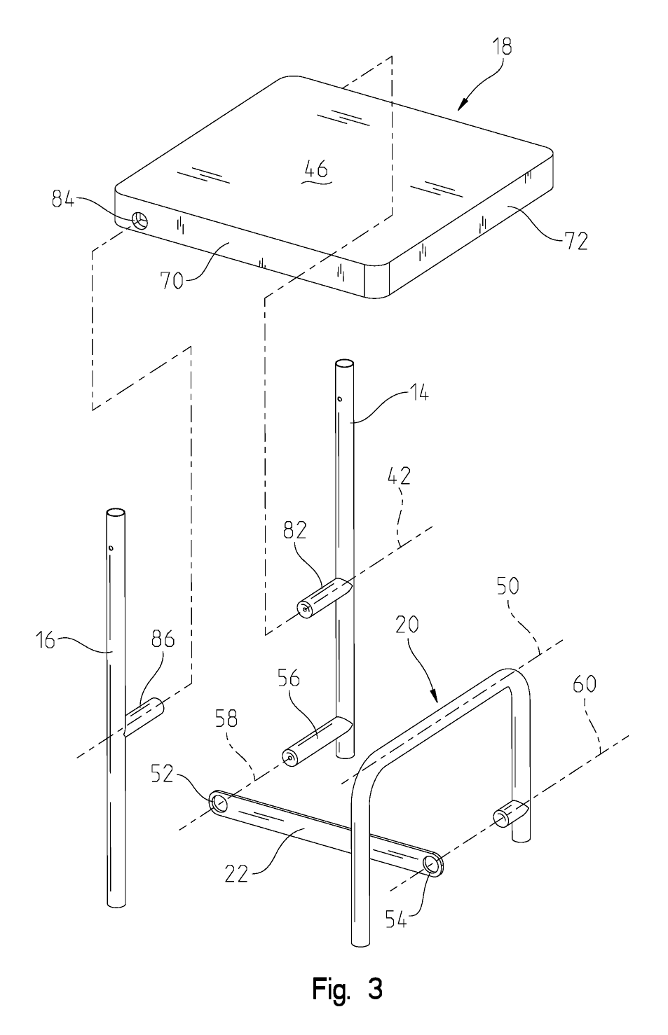

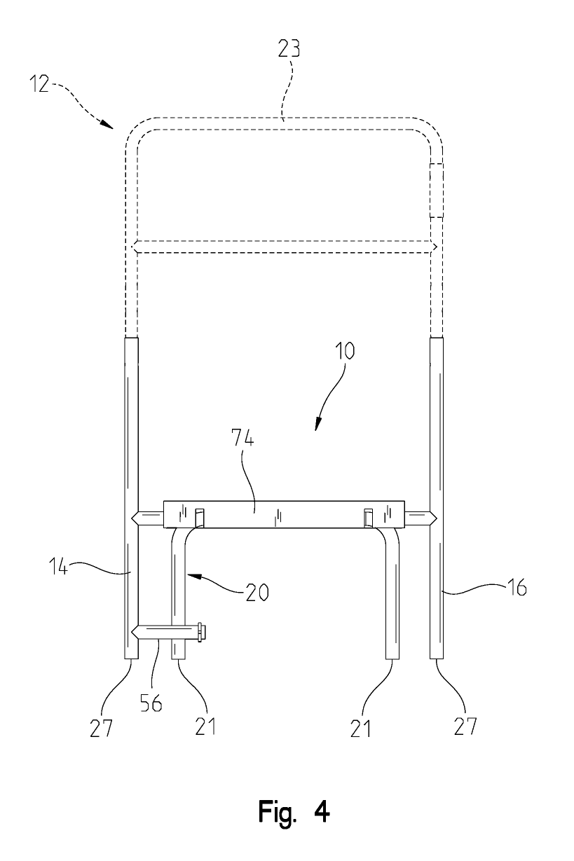

The first leg 16 and the platform 18 are pivotably connected at a first hinge 40, as shown in FIG. 2, such that the platform 18 may pivot about the axis 42 of the first hinge 40. The second leg 14 and platform 18 are also pivotably connected at a second hinge 44, such that the platform 18 may rotate around the axis 42. As shown in FIG. 7C, the first hinge 40 and the second hinge 44 are coaxial. The second leg 14 is held relatively parallel to the first leg 16 by the walker 12 when the folding step 10 is installed. It is contemplated that the first and second leg 16, 14 are not parallel in order to match the leg orientation of the adjustable legs 24. The first and second leg 16, 14 are further restrained from movement by the first and second hinge 40, 44. The first and second hinge 40, 44 keep the legs 16, 14 and platform 18 together. Holding these two legs 16, 14 to the platform 18 could be accomplished by pins or screws or some other means built into the first hinge 40 and second hinge 44.

To install the folding step 10, the first leg 16 and second leg 14 are mated to the tube portions 26, 28 of the walker 12 in place of the leg extensions 24 seen on a traditional walker 12. These two legs 14, 16 would be telescopically and firmly attached to the walker 12 in the same way the normal leg extensions 24 are attached to a walker 12. The walker 12 as shown in FIGS. 1A-C, 2, 4, 5, and 7A-B is a traditional four-legged walker 12.

The platform 18 has an upper surface 46 that may contain non-slip areas or an overall anti-slip coating. As shown, the upper surface 46 is flat but other contours are contemplated. Opposite the upper surface 46 is the unified leg 20. The unified leg 20 is a single tubular member that is an inverted U-shape but the unified leg 20 can take other shapes and still serve the same purpose. It is further contemplated that the unified leg 20 is a single leg that protrudes from the platform 18 when folded down. At terminal ends of the unified leg 20 are feet 21 that are adapted to contact the ground when the platform 18 is folded down. The platform 18 and the unified leg 20 have a third hinge 48 whereby the platform 18 and unified leg 20 may rotate relative to each other on axis 50. The first hinge 40 and the second hinge 44 rotate about axis 42 which is parallel to the axis 50 of the third hinge 48. A linkage 22 runs between the second leg 14 and the unified leg 20. The linkage 22 has a first pivot point 52 on one end and a second pivot point 54 on the opposite end. The first pivot point 52 connects and pivots with respect to the second leg 14 on a first pivot axis 58 at an attachment point 56. The unified leg 20 and the linkage 22 pivot with respect to each other at the second pivot point 54 on a second pivot axis 60. The first and second pivot axes 58, 60 are shown as parallel to axes 42, 50. These components work in conjunction with each other such that the first leg 16 and the second leg 14 may remain parallel to the unified leg 20. This is to keep the overall structure of the folding step 10 steady when the weight of a person is on the upper surface 46. The platform 18 has transverse side walls 68, 70 that intersect lateral walls 72, 74. Lateral wall 74 has a first slot 76 and a second slot 78. An aperture 80 in transverse wall 68 receives a fixed tube 82. The fixed tube 82 extends outward from the first leg 16. Similarly, an aperture 84 in transverse wall 70 receives a fixed tube 86. The fixed tube 86 extends outward from the first leg 16. Both fixed tubes 82 and 86 are coaxial to axis 42.

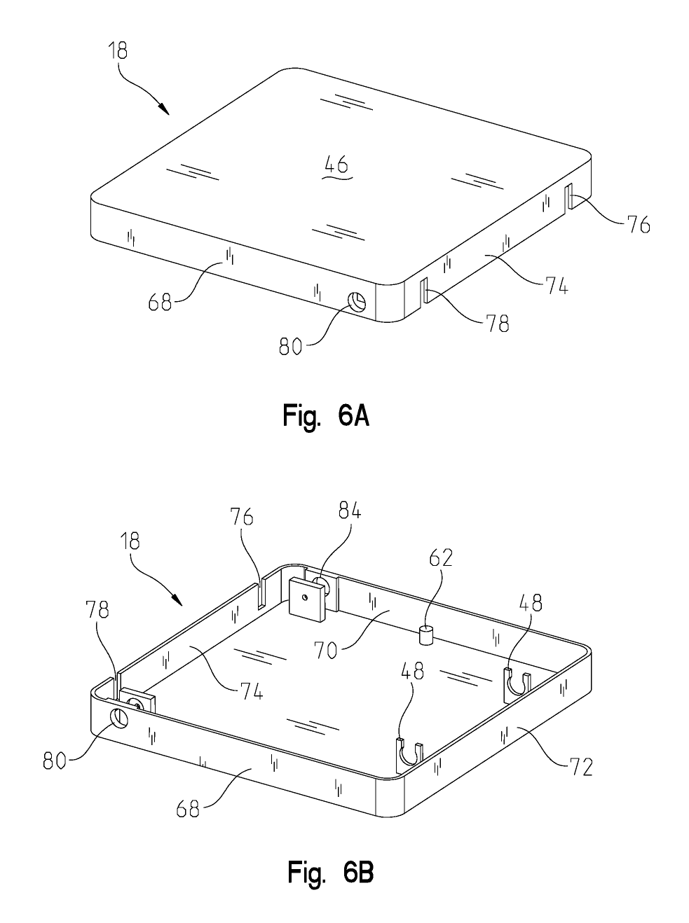

Shown in FIG. 6B, a magnet 62 may be provided for holding the folding step 10 in an upright position and is shown as affixed to the underside of the platform 18. The magnet 62 retains the unified leg 20 when the folding step 10 is folded upright and allows the user to pull the unified leg 20 away from the platform 18 to fold the folding step 10 down. Alternatively, and shown in FIG. 7B, a clip 64 can be affixed to the underside of the step, roughly where the magnet 62 is shown, where the unified leg 20 is held in place until the user pulls it out of the clip 64, allowing the platform 18 to fold down. The clip 64 or magnet 62 may be tall enough to keep the folding step 10 from reaching a full 90 degrees up. This will allow the platform 18 to be pushed down by pushing on the top of the step either on or near lateral wall 72 when the platform 18 is upright. The clip 64 or magnet 62 is strong enough to hold the unified leg 20 in place while the walker is used, but weak enough to release the unified leg 20 if the platform 18 is deliberately pushed. It is contemplated that an alternative attaching folding step 10 instead of the clip 64 or magnet 62 may be positioned such that the step does not fold up completely, allowing the user to pull on the platform 18, near lateral wall 72 to cause the unified leg 20 to disengage and allow the platform 18 to fold down. It is further contemplated that an external release, possibly cable or other linkage driven allows the platform 18 to fold down. It is also further contemplated that a spring force acts on the unified leg 20 or linkage 22 that urges it to pivot away from the platform 18, such that it could be released and the spring force would assist the unified leg 20 to move away and allow the step to be folded without the need to deliberately pull the step from the clip 64 or magnet 62.

The folding step 10 functions such that when folded up has a minimal cross-section. The walker 12 is shown in this configuration in FIGS. 1C and 7C. The folding step 10 can be unfolded by pulling the unified leg 20 out of the clip 64 until the folding step 10 is approximately in the configuration shown in FIG. 1A and 7A. (1B and 7B show the folding step 10 partially unfolded and 1C and 7C show it folded for storage.) From the approximate position shown in FIG. 1B and 7B, the folding step 10 is moved into its functioning position by either pulling the unified leg 20 down or pushing the lateral wall 72 down until the unified leg 20 reaches the ground as shown in FIG. 1A. At this point a person could put their weight on the upper surface 46 and step up to reach an elevated height.

While the walker 12 could have wheels on the first leg and/or the second leg 16, 14, the construction and operation of the folding step 10 make it stable when stepping upon the upper surface 46. This can be accomplished with rubber ends on the feet 21 of the unified leg 20. The step can be installed on the walker such that it either folds inward or outward. This is demonstrated in FIGS. 1A-1C and FIGS. 7A-7C.

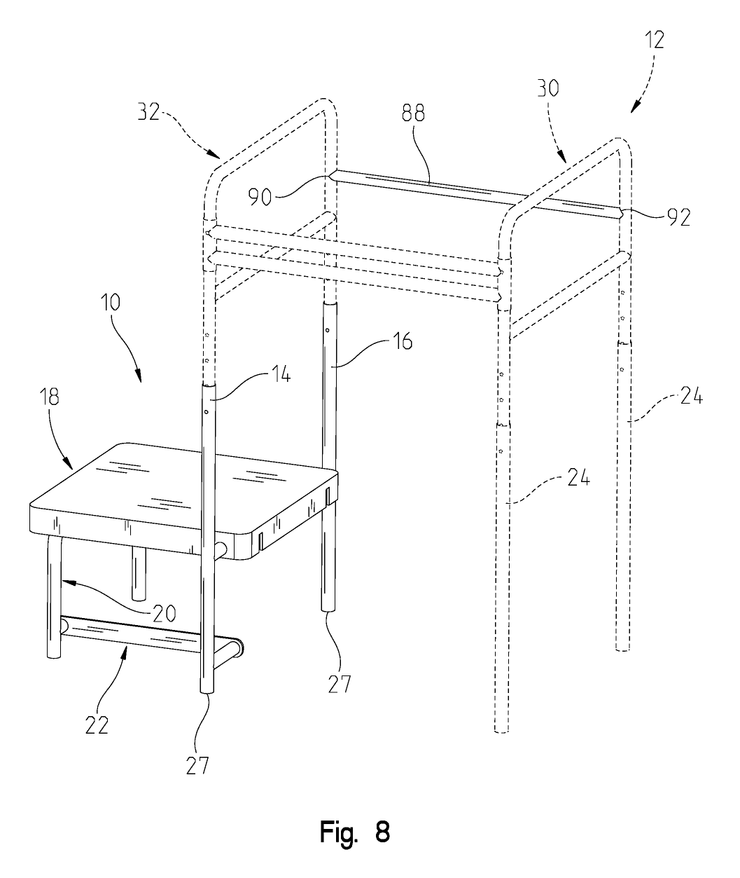

It is contemplated that other features are included as part of the folding step 10. Where a normal walker 12 has four legs and three sides, the sides being bars connecting the legs together, and between one set of legs there is no bar and the user of the walker can step within the walker, a removable bar 88 could be added to create a fourth side. An example of the removable bar 88 is shown in FIG. 8. In this event, if the folding step 10 was folded to the outside of the walker 12, as opposed to the inside of the walker, the additional bar, when put in place, would create a stronger and more stable structure. As shown in FIG. 8, the bar 88 affixes to the walker 12 at connection points 90, 92 to lock the left side 30 to the right side 32. A person helping the user could hold the walker 12 steady while the user stepped up onto the platform 18 and into an SUV for instance.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

1. A folding step adapted to be removably affixed to and separate from a mobility device having at least two vertical members with telescopically removable legs, said telescopically removable legs adapted to contact a substantially horizontal surface being separate from said device, said folding step comprising:
a first step leg being an elongate member having a foot at a terminal end, said foot adapted to contact said substantially horizontal surface, said first step leg having a mating portion located near a distal end oppositely located from said foot, said mating portion adapted to be telescopically mated with and affixed to one of said vertical members of said mobility device;
a second step leg being an elongate member that is parallel to and spaced from said first step leg, said second step leg having a foot at a terminal end, said foot adapted to contact said horizontal surface, said second step leg having a mating portion located near a distal end oppositely located from said foot, said mating portion adapted to be telescopically mated with and affixed to another of said vertical members of said mobility device;
a platform having transverse sidewalls that intersect lateral walls, said platform affixed to said first step leg at a first hinge and said second step leg at a second hinge, said platform having a planar upper surface, said platform moveable with respect to said first and second step legs between a stored position defined by said platform being located between said first and said second step legs and a use position defined by said platform being perpendicular to said first and said second step legs;
a support leg pivotably affixed to said platform at a third hinge, said support leg pivotable between a stored position and an use position, said support leg having a support foot adapted to contact said substantially horizontal surface, a linkage being an elongate member having a first pivot point pivotably affixed to one of said first or second step legs, said linkage having a second pivot point pivotably affixed to said support leg when said platform is in said stored position, said support leg is in said stored position and located between said transverse and lateral walls; and
a retaining feature adapted to releasably affix said platform in said stored position.

2. The folding step according to claim 1, said platform having a slot adapted to receive a portion of said linkage, said linkage substantially located in said slot when said platform is located in said stored position.

3. The folding step according to claim 2, said first and second hinge forming a pivot axis, said platform adapted to rotate around said pivot axis, said first hinge having a fixed portion extending substantially perpendicularly from said first step leg through an aperture in said platform, said second hinge having a fixed portion extending substantially perpendicularly from said second step leg through an aperture in said platform.

4. The folding step according to claim 3, said retaining feature being a clip adapted to partially circumscribe a portion of said support leg.

5. The folding step according to claim 3, said retaining feature being made from a material having magnetic attraction to a portion of said support leg.

6. The folding step according to claim 3, said support leg is parallel to said first step and said second step leg as said platform moves between said stored position and said use position.

7. The folding step according to claim 3, said support leg being formed from a single elongate member into a U-shape, said support foot located at terminal ends of said elongate member.

8. The folding step according to claim 1, a removable bar adapted to contact and affix opposite vertical members of said mobility device.

9. The folding step according to claim 1, each of said vertical members having a button being urged and extending outward of a corresponding outer diameter, said first step leg having a series of holes extending therethrough, said series of holes adapted to receive said button to fix the position of said first and second step leg to said mobility device.

10. A folding step adapted to be removably affixed to a mobility device having at least two substantially vertical members with telescopically movable legs, said legs adapted to contact a substantially horizontal surface being separate from said device, said folding step comprising:
a first step leg being an elongate member having a foot at a terminal end, said foot adapted to contact said substantially horizontal surface, said first step leg having a first mating portion located near a distal end oppositely located from said foot, said first mating portion adapted to be telescopically mated with and affixed to one of said vertical members of said mobility device;
a second step leg being an elongate member that is spaced from said first step leg, said second step leg having a foot at a terminal end, said foot adapted to contact said substantially horizontal surface, said second step leg having a second mating portion located near a distal end oppositely located from said foot, said second mating portion adapted to be telescopically mated with and affixed to another of said vertical members of said mobility device;
a platform having transverse sidewalls that intersect lateral walls, said platform being pivotably affixed to said first step leg and said second step leg, said platform having an upper surface, said platform pivotable with respect to said first and second step legs between a stored position defined by said platform being located substantially between said first and second step legs and a use position defined by said platform being substantially perpendicular to said first and said second step legs;
a support leg pivotable between a stored position and an use position, said support leg pivotably affixed to said platform at a third hinge, said support leg having a support foot adapted to contact said substantially horizontal surface, a linkage being an elongate member having a first pivot point pivotably affixed to one of said first or said second step legs, said linkage having a second pivot point pivotably affixed to said support leg, when said platform is in said stored position, said support leg is in said stored position and located between said transverse and lateral walls; and
said platform having a retaining feature adapted to releasably affix said platform in said stored position.

11. The folding step according to claim 10, said platform having a slot adapted to receive a portion of said linkage, said linkage substantially located in said slot when said platform is located in said stored position.

12. The folding step according to claim 11, said first and second hinge forming a pivot axis, said platform adapted to rotate around said pivot axis, said first hinge having a fixed portion extending substantially perpendicularly from said first step leg through an aperture in said platform, said second hinge having a fixed portion extending substantially perpendicularly from said second step leg through an aperture in said platform.

13. The folding step according to claim 12, said retaining feature being a clip adapted to partially circumscribe a portion of said support leg.

14. The folding step according to claim 12, said retaining feature being made from a material having magnetic attraction to a portion of said support leg.

15. The folding step according to claim 12, said support leg is parallel to said first step and said second step leg as said platform moves between said stored position and said use position.

16. The folding step according to claim 12, said support leg being formed from a single elongate member into a U-shape, said support foot located at terminal ends of said elongate member.

17. The folding step according to claim 10, a removable bar adapted to contact and affix opposite vertical members of said mobility device.

18. A mobility device adapted to contact a substantially horizontal surface being separate from said device, said mobility device comprising:
a first side hingedly connected to a first end of a front member, a second side hingedly connected to a second end of said front member, each of said sides having a pair of substantially vertical members;
a first step leg being an elongate member having a foot portion at a terminal end, said foot portion adapted to contact said substantially horizontal surface, said first step leg having a first mating portion located near a distal end oppositely located from said foot portion, said first mating portion telescopically affixed to one of said vertical members of said mobility device;
a second step leg being an elongate member that is spaced from said first step leg, said second step leg having a foot portion at a terminal end, said foot portion adapted to contact said substantially horizontal surface, said second step leg having a second mating portion located near a distal end oppositely located from said foot portion, said second mating portion telescopically mated with and affixed to another of said vertical members of said mobility device;
an adjustable step leg being an elongate member and having a foot portion at a terminal end and a mating portion located near a distal end oppositely said foot portion, said adjustable step leg telescopically affixed to another of said vertical members;
a platform being pivotably affixed to said first step leg and said second step leg, said platform having an upper surface, said platform pivotable with respect to said first and second step legs between a stored position defined by said platform being located substantially between said first and said second step legs and a use position defined by said platform being substantially perpendicular to said first and said second step legs;
a support leg pivotably affixed to said platform at a third hinge, said support leg having a support foot portion adapted to contact said substantially horizontal surface, a linkage being an elongate member having a first pivot point pivotably affixed to one of said first or said second step legs, said linkage having a second pivot point pivotably affixed to said support leg; and
said platform having a retaining feature adapted to releasably affix said platform in said stored position.

19. The folding step according to claim 18, said retaining feature being a clip adapted to partially circumscribe a portion of said support leg.

20. The folding step according to claim 18, said retaining feature being made from a material having magnetic attraction to a portion of said support leg.
